(19) United States
(12) Patent Application Publication
(10) Pub. No.: US 2018/0374349 A1
(43) Pub. Date: Dec. 27, 2018

(54) PARKING SPACE ASSIGNMENT IN A BUSINESS PARKING LOT

(71) Applicant: Microsoft Technology Licensing, LLC, Redmond, WA (US)

(72) Inventor: David Mowatt, Dublin (IE)

(21) Appl. No.: 15/631,898

(22) Filed: Jun. 23, 2017

(51) Int. Cl. G08G 1/14; G07B 15/02; G06F 17/30

(52) U.S. Cl. CPC G08G 1/14; G06Q 10/00; G06F 17/30286; G07B 15/02

(57) ABSTRACT

Systems, methods, and software are disclosed herein allocating parking spaces in a parking lot. In an implementation, program instructions direct a processing system to enumerate a set of vehicles likely to park in the parking lot during a given time period, each vehicle associated with a respective driver; determine an availability of each parking space of the plurality of parking spaces during the given time period; and identify at least one decision factor corresponding with each respective driver, wherein the at least one decision factor comprises a priority of a respective driver to be assigned a parking space. The program instructions further direct the processing system to assign a parking space for a vehicle for the given time period based on the availability of the assigned parking space and based on at least one decision factor. The respective driver of the authorized vehicle is notified via a user interface.

### TECHNICAL BACKGROUND

Not all businesses are fortunate to have sufficient spaces in their parking lots to accommodate all vehicles of drivers visiting the business at one time. While employees may want to park near their employer on a regular basis, there may be other drivers to accommodate such as employees from other buildings, visitors, disabled drivers, drivers making deliveries, customers attending events, VIP customers attending important meetings, etc. In addition, where the workforce is mobile, there may be fluctuation in parking with particular events (either on site or elsewhere) causing increases or reductions in parking on a given day.

Not all employees may be considered equal. Certain employees (e.g., executives) may be viewed as needing preferential treatment based on their job duties compared with other employees considered to have a less-important status (e.g., individuals contracted to perform building management services). Other types of employees may also be given preferential treatment based on their health status, based on a rewards program, based on their working hours, etc.

To address these concerns, some businesses may allow parking based on a first-come, first-serviced basis. However, allowing parking in a reduced-space lot on a first-come, first-served basis may benefit the employees who arrive early to work regardless of their preferred status and may force those employees given a high preferred status to seek parking elsewhere and farther away. Other businesses may use assigned parking spaces. However, drivers who may benefit from parking in the reduced-space lot when assigned parking spaces are not being used are unable to do so.

Thus, it would be advantageous to assign parking spaces in an under-sized parking lot in a manner that overcomes the aforementioned drawbacks.

### Overview

Examples discussed herein relate to allocation and assignment of parking spaces in a business parking lot. In an implementation, a computing apparatus comprises one or more computer readable storage media; a processing system operatively coupled with the one or more computer readable storage media; and program instructions stored on the one or more computer readable storage media for allocating a plurality of parking spaces in a parking lot. When executed by the processing system, the program instructions direct the processing system to enumerate a set of vehicles likely to park in the parking lot during a given time period, each vehicle associated with a respective driver; determine an availability of each parking space of the plurality of parking spaces during the given time period; and identify at least one decision factor corresponding with each respective driver, wherein the at least one decision factor comprises a priority of a respective driver to be assigned a parking space. The program instructions further direct the processing system to assign a parking space (“assigned parking space”) of the plurality of parking spaces for a vehicle (“authorized vehicle”) of the set of vehicles for the given time period based on the availability of the assigned parking space and based on at least one decision factor and to notify, via a user interface, the respective driver of the authorized vehicle of the assigned parking space.

In another implementation, a method for allocating parking spaces in a parking lot comprises enumerating a set of vehicles likely to park in the parking lot during a given time period, each vehicle associated with a respective driver; determining an availability of each parking space of the plurality of parking spaces during the given time period; and identifying at least one decision factor corresponding with each respective driver, wherein the at least one decision factor comprises a priority of a respective driver to be assigned a parking space. The method also comprises assigning an assigned parking space of the plurality of parking spaces for an authorized vehicle of the set of vehicles for the given time period based on the availability of the assigned parking space and based on at least one decision factor and notifying the respective driver of the authorized vehicle of the assigned parking space via a user interface.

In another implementation, one or more computer readable storage media have program instructions stored thereon for allocating parking spaces in a parking lot, wherein the program instructions, when executed by a processing system, direct the processing system to enumerate a set of vehicles likely to park in the parking lot during a given time period, each vehicle associated with a respective driver; determine an availability of each parking space of the plurality of parking spaces during the given time period; and identify at least one decision factor corresponding with each respective driver, wherein the at least one decision factor comprises a priority of a respective driver to be assigned a parking space. The program instructions also direct the processing system to assign a reserved parking space of the plurality of parking spaces for an authorized vehicle of the set of vehicles for the given time period based on the availability of the assigned parking space and based on at least one decision factor and to notify the respective driver of the authorized vehicle of the assigned parking space via a user interface.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a schematic diagram of system for automatically assigning a parking space to a vehicle in a parking lot according to some embodiments.

FIG. 2 is a block diagram of a server included in the system of FIG. 1 according to some embodiments.

FIG. 3 is a flow diagram illustrating a method for entering data into people and location databases according to some embodiments.

FIG. 4 is a process flow diagram of a method for automatically assigning a parking space to a vehicle in a parking lot according to some embodiments.

FIG. 5 is a flow diagram illustrating an ad-hoc automatic parking space assignment method according to one embodiment.

FIG. 6 is a flow diagram illustrating a pre-booking automatic parking space assignment method according to one embodiment.

FIG. 7 illustrates a computing system suitable for implementing the software technology disclosed herein, including any of the applications, architectures, elements, processes, and operational scenarios and sequences illustrated in the Figures and discussed below in the Detailed Description.

### DETAILED DESCRIPTION

Before any embodiments are explained in detail, it is to be understood that the embodiments described herein are not limited in their application to the details of construction and the arrangement of components set forth in the following description or illustrated in the following drawings. Embodiments may be practiced or carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and notifications may be performed using any known means including direct or indirect wired connections, wireless connections, and combinations thereof. Also, functionality described as being performed by one device may be distributed among a plurality of devices.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

Technology is disclosed herein that allows parking space assignment for under-sized parking lots based at least on parking lot characteristics, individual parking space characteristics, and driver or operator characteristics as examples. Preferential treatment of employees is considered as well as re-allocation of reserved spots based on schedules or schedule changes. Businesses can thus make deliberate decisions about who should park closest to the building entrances and who (in cases of overcrowding) gets bumped and has to park elsewhere. Embodiments of the invention allow businesses to ensure a controlled balance between visiting-customer happiness and employee happiness and fairness.

A technical effect provided by the technology disclosed herein is the ability of a reduced-space parking lot to have its parking spaces assigned to drivers based on characteristics of the parking lot as well as characteristics of the drivers wanting to use the parking lot. Parking lot and user characteristics are weighted to determine who gets to park in the parking lot and who has to find parking elsewhere.

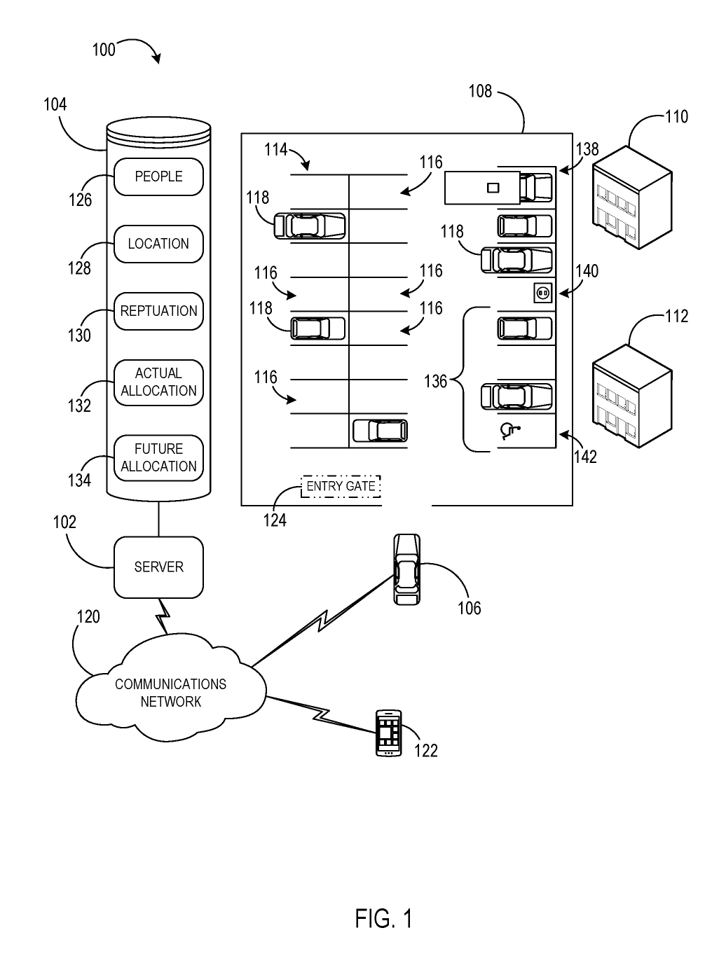

FIG. 1 schematically illustrates a system 100 for automatically assigning a parking space to a vehicle in a parking lot. As illustrated in FIG. 1, the system 100 includes a computer or server 102 and one or more databases, such as one or more local databases 104. Each database may be a database housed on a suitable database server communicatively coupled to accessible by the server 102 and may be a part of a cloud-based database system. Also, it should be understood that, in some embodiments, the server 102 and the database 104 (or portions thereof) may reside on the same physical machine or in the same data center. Database 104 may be located in the same location as the server 102 and may communicate with the server 102 over a wired or wireless connection, which may be a direct connection or an indirect connection over a communications network. Alternatively, database 104 may be located remotely from the server 102 and may communicate with the server 102 over a wired or wireless connection, directly or indirectly connected over a communications network. It should also be understood that the system 100 is provided as an example and, in some embodiments, the system 100 may include additional components. For example, the system 100 may include multiple servers 102 and multiple databases 104 or a combination thereof.

As described in more detail below, embodiments of the system 100 automatically determine a parking space assignment for a vehicle 106 within a parking lot 108. The vehicle 106 may be a car, a truck, a van, a motorcycle, or other private or commercial automobile capable of parking in a parking lot 108, and the parking lot 108 may be located near or may directly or indirectly serve one or more businesses 110, 112 (described in more detail below) and includes a plurality of parking spaces 114. At any given time, the plurality of parking spaces 114 may be comprised of one or more unoccupied parking spaces 116, one or more occupied spaces (for example, occupied by a parked vehicle 118), or a combination of both. It should be understood that the parking lot 108 illustrated in FIG. 1 is presented by way of example and embodiments described herein may be used with different sizes and configurations of parking lots with various numbers of parking spaces. Embodiments described herein may also be implemented partially to automatically assign parking spaces from portions of a parking lot reserved for such automatic assignment while leaving other portions unassignable.

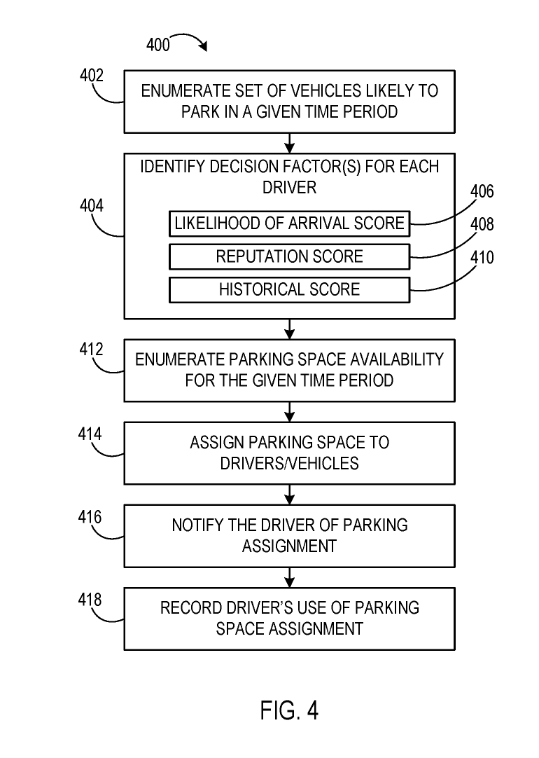

As described in more detail below with respect to FIG. 4, the server 102 automatically determines a parking space assignment for the vehicle 106 within the plurality of parking spaces 114. After determining the parking space assignment, the server 102 transmits the parking space assignment a communications network 120. In some embodiments, the server 102 transmits the parking space assignment to the vehicle 106. For example, in some embodiments, the vehicle 106 includes components (for example, a microprocessor, a network interface, and a human machine interface, such as an internet-connected infotainment system) that enable the vehicle 106 to receive, process, and output the parking space assignment to an occupant of the vehicle 106. Alternatively or in addition, in some embodiments, the server 102 may transmit the parking space assignment to a mobile communication device 122, such as a smart phone, a tablet computer, a smart watch or other wearable, or the like, carried by an occupant of the vehicle 106. The mobile communication device 122 may be communicatively coupled to the server 102 via the communications network 120 and may be operated by a driver or passenger of the vehicle 106. Also, in some embodiments, the server 102 may transmit the parking space assignment by issuing a ticket or displaying a quick response (QR) or other machine-readable code with an entry gate or kiosk 124.

The communications network 120 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, and combinations or derivatives thereof.

In some embodiments, as illustrated in FIG. 1, the local database 104 electronically stores or accesses people data, location data, reputation data, actual allocation data, and future allocation data. It should be understood that, in some embodiments, the data stored in the database 104 may be distributed among multiple databases that communicate with the server 102 and, optionally, each database may store specific data used by the server 102 as described herein. For example, in some embodiments, the local database 104 may be distributed as a people database 126, a location database 128, a reputation database 130, an actual allocation database 132, and a future allocation database 134, or a combination thereof, which may be included in a common database server or separate database servers, included in the server 102, or a combination thereof.

In some implementations, only one business's information may be held in the database, but in others (e.g., in the case where a parking lot is shared by multiple businesses), multiple organisations' employees may be stored. In some implementations, the people database may be only the source of this information, while in others, certain properties and/or entries may be stored in a separate accessible repository (e.g., a Microsoft Azure Active Directory may contain information about employees and job titles).

The people data in the people database 126 may include a list of drivers (e.g., employees, visitors, etc.) together with information about their vehicle. The information associated with the driver may be some form of identifier to know how to identify the driver as his assigned vehicle approaches the parking lot 108. The identifier may be, for example, a license plate, a windshield tag, or another personal identifier for the driver (e.g., the driver's phone number or badge number). Some of these people may be employees whose job titles and responsibilities are known (e.g., from president to individual worker). Some may be known customers or people making deliveries. Still others may be unknown to the system 100 (e.g., unidentified people who are arriving at the parking lot and asking to park ad-hoc).

The vehicle information in the people database 126 may include a vehicle size (e.g., the length, width, height, or weight of vehicle); a vehicle power source (e.g., whether the vehicle is an electric vehicle); a vehicle charge level (e.g., the charge remaining in an electric vehicle's battery system); a special passenger type (e.g., disabled, elderly, expectant mother, etc.); and the like. The vehicle data may be collected from vehicle owners or operators. For example, a vehicle owner or operator may register their vehicle with the server 102 using a website or a software application (e.g., executed by a mobile communication device). The vehicle identifier may be based on governmental data (e.g., a license plate number or vehicle identification number (VIN)), may be provided by the owner or operator of the vehicle, or may be assigned as the vehicle arrives if no pre-arranged information was provided.

The locations data in the location database 128 may include one or more parking lots associated with the business 110, 112. This database contains an enumeration of all parking spaces within each parking lot. The parking space data may include parking space identifiers (e.g., alphanumeric codes) for each of the plurality of parking spaces 114, a location of each of the plurality of parking spaces 114, and other metadata for each parking space. Metadata for a parking space may include a desirability score that may be assigned manually or that may be computed automatically. For example, the desirability score may be based on a “time to entrance” score for each parking space, which represents the time it would take an occupant of the vehicle to reach the buildings 110, 112 from the parking space 114. In some implementations, different scores may be computed based on the time to walk to a particular entrance that is annotated as being close to a location of interest (e.g., the entrance next to the showroom vs. the customer briefing room vs. a conference room vs. the sales office, etc.). In cases of shared parking lots, certain spaces 136 may be annotated as being usable only by a given company with the remaining spaces available for either company. The metadata for a parking space may include the length, width, height, or weight of vehicle that the parking space may accommodate; whether the parking space 114 is one with an electric charging point (138) or is a space for large vehicles (140), disabled access (142); whether the parking space is covered or exposed; whether the parking space is located in a heated or unheated structure; whether the space has cover from the weather (sunshine or snow); and the like.

The reputation data in the reputation database 130 can track how often the driver has correctly indicated that he will or will not be parking. In some implementations, this data can allow organizations to save (and not give away) parking spaces for drivers who say they will arrive later, in a way that the system won't be ‘cheated’ by drivers who always say they will arrive, yet frequently do not actually arrive. The reputation data may include data for individual drivers that records historical data regarding whether the driver gave an indication that a parking space was needed and how many timed the driver actually parked in the parking lot 108. If the driver failed to arrive (e.g., he had a reserved space but failed to indicate they would be travelling or on vacation and thus not need the reserved space), this would be recorded. This database can be used to reward drivers who feed accurate information into the system 100. The reputation may be calculated based on a comparison of the number of parking space assignments to the respective driver with a number of actual uses of the number of the number of parking space assignments by the respective driver.

The actual allocation data in the actual allocation database 132 contains information regarding the up-to-date information about which spaces 114 are assigned to which drivers' vehicles 118 currently in the parking lot 108. It may further contain historical information about which drivers were allocated which spaces 114 on a given day and the number of times a driver has been declined parking and when. It is to be understood that blocks 302-306 of method 300 may be independently performed of each other. For example, entering future requests and entering temporary visitors may typically be daily activities, while registering employees will typically happen less frequently. As such, implementations of method 300 in some embodiments does not require performing each block 302-306 every time. Instead, one or more of blocks 302-306 may be performed.

The system 100 finally has future allocation data in the future allocation database 134 that contains a list of people/drivers (e.g., employees and visitors) who are requesting to park in the parking lot 108 including future times on the same today or on a future day.

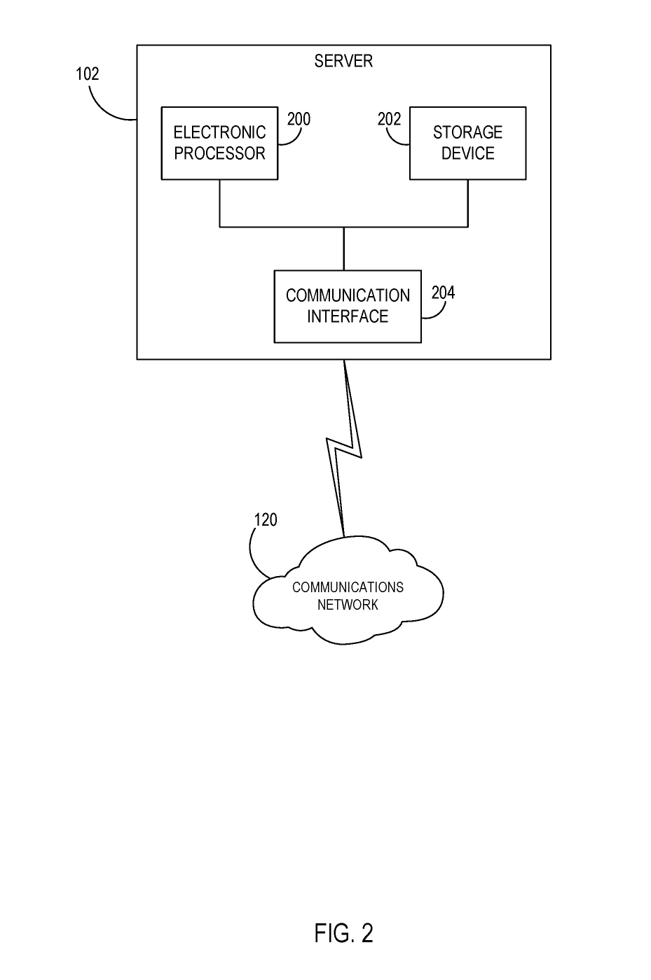

FIG. 2 schematically illustrates the server 102 in more detail. As illustrated in FIG. 2, the server 102 includes an electronic processor 200 (e.g., a microprocessor, application-specific integrated circuit (ASIC), or another suitable electronic device), a storage device 202 (for example, a non-transitory, computer-readable storage medium), and a communication interface 204, such as a transceiver, for communicating over the communications network 120 and, optionally, one or more additional communication networks or connections. It should be understood that the server 102 may include additional components than those illustrated in FIG. 2 in various configurations and may perform additional functionality than the functionality described in the present application. Also, it should be understood that the functionality described herein as being performed by the server 102 may be distributed among multiple devices, such as multiple servers and may be provided through a cloud computing environment, accessible by components off the system 100 via the communications network 120.

The electronic processor 200, the storage device 202, and the communication interface 204 included in the server 102 communicate over one or more communication lines or buses. The electronic processor 200 is configured to retrieve from the storage device 202 and execute, among other things, software related to the control processes and methods described herein. For example, the methods and flow diagrams described as being performed by the server 102 and, in particular, the electronic processor 200. However, it should be understood that in some embodiments, portions of the methods and flow diagrams may be performed by other devices, including for example, the mobile communication device 122 or a computer in or communicatively coupled to the vehicle 106.

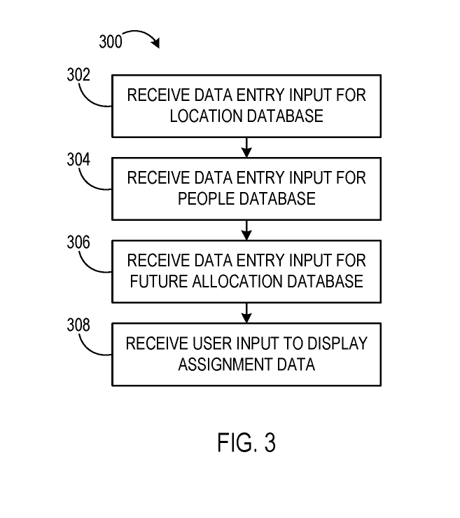

FIG. 3 is a flow diagram illustrating a method 300 for entering data into the people and location databases 126, 128 according to some embodiments. At block 302, an administrator within the business may define the characteristics and parameters for each parking space 114 available in the parking lot. For example, the administrator may enter the data described above such as the parking space identifiers, the location of each of the plurality of parking spaces 114, the desirability score, identification of shared parking spaces 136, vehicle size and weight data that the parking space may accommodate, and special accommodation parameters (e.g., electric charging point (138), large vehicles (140), disabled access (142)), and the like via an administrator portal. The administrator may decide to pre-allocate a bare minimum number of spaces for ad-hoc visitors via the administrator portal.

The administrator may further register all employees in the people database 126 at block 304. For example, the administrator may enter the data described above such as the driver and vehicle information. Different objectives may be met in setting an importance score for the employee's job role or seniority according to a ranked system or in setting the importance score to an equal value for all employees. The administrator may further connect each employee's calendar to the system 100, such as Microsoft Office 365. If separate, an employee vacation system and/or other systems may also be connected. Additionally, block 302, the employee may have access to input, edit, or delete his own information to add or modify information. For example, the driver may have access to a second car and would want to register the second car into the system 100.

The administrator or employee may have access to the people database 126 in order to register temporary visitors to allow the system 100 to determine their parking. This allows the visitor to be pre-entered into the system 100 so that an ad-hoc request for parking can be avoided. This is possible when the visitor is known to be visiting the business 110, 112 ahead of time. The visitor's importance score may be set to put a priority in the system 100 for distinguishing highly-valued visitors from visiting building maintenance repair personnel, for example.

At block 306, the administrator or employee may enter a request into the future allocation database 134 for a parking space 114 at a known future date in order to pre-book the parking space. For example, the request may seek registration to register that visitors are expected, for example, to a particular event that is expected to have 10 visitors each arriving by car. In another example, a particular client may be coming to the office to sign a particular deal. In some implementations, all drivers who have not yet parked are assigned a priority score, which is computed using multiple sub-scores. Unknown drivers are also assigned a score. This means that at any given moment, and based on what is registered in the system, the system may know which drivers will be assigned a parking space and which will not. In some implementations, this assigned/unassigned decision may change dynamically through various events articulated below including but not limited to the arrival of unexpected vehicles and the confirmation that certain drivers will not be arriving as previously expected. The events are entered into the future allocation database 134 are assigned a stack rank score. For example, regular visitors may get a score of 0.6 or 60% while important clients may get a score of 0.9 or 90%. A delivery vehicle which needs to park closely and which may only need to park for a short amount of time (e.g., 10 minutes) may get a score of 0.9 or 90%.

Conversely, an administrator may register that all 50 people from the Sales department will be at an offsite event, and thus not need parking. Accordingly, the stack rank for the Sales employees will go from their average (e.g., 0.5 or 50%) to something much lower (e.g., 0.05 or 5%). Particular employees may opt out of such events, reverting their rank for the day to higher levels.

At block 308, the administrator or employee may enter a request to view assigned parking space data. After parking spaces have been assigned as described herein, a user or administrator may want to view the assignment data. Accordingly, the assignment data may be requested by the administrator followed by the display of the assignment data on a user interface.

It is to be understood that blocks 302-308 of method 300 may be independently performed of each other. For example, entering future requests and entering temporary visitors may typically be daily activities, while registering employees will typically happen less frequently. As such, implementations of method 300 in some embodiments does not require performing each block 302-308 every time. Instead, one or more of blocks 302-308 may be performed.

FIG. 4 is a flow diagram illustrating an automatic parking space assignment method 400 for automatically determining parking space availability in the parking lot 108 for the vehicle 106, performed by the server 102 according to one embodiment. As illustrated in FIG. 4 at block 402, method 400 begins calculating parking space assignment by enumerating a set of vehicles likely to park in a given time period. The administrator may set the time period according to the business needs. In one example, the time period may be set to determine daily parking access such as for a business that does not get many outside visitors and that has just one working shift. In another example, the time period may be set to larger or smaller increments (e.g., 1 month, 1 week, 1 hour, 30 minutes, 15 minutes, etc.) based on the parking needs.

Determining the vehicles likely to be on-site may include accessing the electronic calendars of the drivers in the people database 126 to determine the times that would be needed. In one example, the method 400 may look for specific calendar items indicating that parking is desired. Such calendar items may have one or more identifiers detailing the parking needs such as keywords or specific times for parking on the calendered days. These calendar items may be in the employee's personal calendar or in a shared calendar. In one embodiment, method 400 may consider all employees willing to park as eligible for requesting parking unless a calendar item or object indicates the contrary. For example, calendared vacations or business trips may remove the employee from the parking reservation system 100 to avoid negative effects to the driver's reputation score. If an online calendar is not available for an employee or visitor in the people database 126, one or more parameters for the driver in the people database 126 may indicate the parking times that would be needed. In systems 100 that allow for a level of granularity of less than a day (e.g., hour-by-hour planning of parking allocation), the location(s) where an employee will be off-site based on the calendar items can be used to determine the travel time to the parking lot 108 to estimate when a parking space 114 will be needed. For example, an employee may be off-site through the morning but may return in the afternoon. In this case, the driver's vehicle may be enumerated during the afternoon hours when the employee is expected to return in order to consider the employee for parking assignment.

The parking space 114 is reserved for multiple time periods when the time period is shorter than the expected length of stay of the employee or visitor. For example, an employee who typically parks an entire eight-hour shift would need multiple parking reservations in a system 100 with 15-minute time period blocks. In addition, the system 100 may automatically assign parking times before and after the employee's expected work hours to give the employee times to arrive and leave before and after the shift.

At block 404, for the vehicles/drivers likely to need a parking space 114 for the given time period, one or more decision factors are identified to order the vehicles and respective drivers in a ranked order. In this manner, the vehicles/drivers are prioritized to be assigned a parking space. Identifying the decision factor(s) 404 includes identifying one or more decision factors having a bearing on the allocation score. One decision factor includes a likelihood of arrival score 406 for each driver to actually arrive at the parking lot 108 and benefit from an assigned parking space. The likelihood of arrival score 406 can indicate that, for historical time periods similar to the given time period being calculated, the driver also needed and/or used a parking space 114. For employees and recurring visitors, this may be done by retrieving their historical information data in the actual allocation database 132 and analyzing the data to determine the historical days and times similar to the given time period that they arrived and parked in a parking space 114. If the employee works a typical workweek, for example, a higher likelihood of arrival score 406 may be given for the given time on a working day. In one embodiment, the driver or the vehicle has a communication device (e.g., mobile communication device 122) that communicates with the server 102 regarding the vehicle's location. If the system 100 is calculating or re-calculating the assigned parking spaces and detects that the driver is traveling toward the parking lot 108, the likelihood of arrival score 406 may be increased. Conversely, if the vehicle is traveling away from the parking lot 108, the likelihood of arrival score 406 may be decreased. Furthermore, a driver may communicate from his device 122 to indicate that he is in transit and is explicitly request a parking space 114. In other implementations, the mobile communication device 122 may relay the driver's current location to the parking system 100, and this implicitly communicates that the driver is en route (or travelling to another destination).

The reputation database 130 may be accessed to retrieve the driver's reputation with the parking assignment system 100 to identify another decision factor, a reputation score 408, that affects the vehicle/driver priority 404. All new drivers entered into the system 100 may automatically receive a baseline reputation such as 0.5 or 50%, for example. Alternatively, the baseline reputation may be set by the administrator for a new employee or by the administrator or employee logging in an expected first-time visitor. As the driver properly requests parking assignment and uses assigned parking spaces 114 when assigned, the driver's reputation increases. However, failure to indicate ahead of time that a previously-assigned parking space 114 will not be needed decreases the driver's reputation. In one embodiment, the change in the driver's reputation is affected in the same manner between the increase and decrease effects. For example, a decrease in the reputation caused by not using a reserved space 114 may be greater than the increase in the reputation as a result of using the reserved space 114 and vice versa.

The actual allocation database 132 may be accessed to identify a historical score 410 decision factor by retrieving historical information regarding how many times, both recently and beyond, the driver has received parking space reservations, how many times the driver or vehicle was denied parking space reservations, when the driver has parked, when the driver has not parked, etc. In one embodiment, if the driver was recently bumped and did not receive a parking space, the driver may be compensated the next time with an increase in his historical score 410.

Other attributes and decision factors can also affect the vehicle/driver priority 404. The employee's job seniority or job position (e.g., executive officer, supervisor, manager, etc.) may entitle an employee to a greater guarantee of assigned parking spaces. For example, a senior employee has a greater guarantee of an assigned parking space than an employee more junior in status. In another example, an employee supervisor may be given a greater guarantee of an assigned parking space than the employees supervised by the supervisor. In addition, there may be particular needs (e.g., disability, pregnancy) that lead to the business to provide a better guarantee of a parking space 116. The business may decide to encourage drivers of electric cars by giving them a higher score versus those having non-electric cars. Employees known to arrive early in the morning or leave later in the evening may be given spaces closer to the building to lessen their walk to the buildings 110, 112 in the dark.

All of the sub-scores above 406-410 may be joined, for example, by weighting them and adding them together, to form the single stack rank score for the parking time period. A numbered list of drivers may be created to determine the order in which drivers are assigned parking spots based on availability.

At block 412, the system 100 computes or enumerates how many parking spaces 116 are available for parking assignment. The system 100 may analyze the location database 128, the actual allocation database 132, and the future allocation database 134 available parking spaces 114 for reservation/assignment. The location database 128 can indicate the total number of spaces 114 available to the business, which may include all spaces 114 in the database or may be less than all spaces 114 due to temporary or long-term unavailability for parking purposes due to other reasons such as maintenance or special reservations. The actual allocation database 132 may be analyzed to determine the total quantity of spaces that are presently occupied or unoccupied, and the future allocation database 134 may be analyzed to determine the number of reserved parking spaces 114 for a requested future time period.

With the data from blocks 402, 404, and 412, the system 100 assigns or reserves parking spaces 114 to drivers/vehicles 106 at block 414. Based on the allocation score, a driver is assigned a parking space 114 if the number of spaces 114 available exceeds the driver's position in the numbered driver list and if the vehicle 106 meets the specification of the available spaces 114. For example, if the driver is ranked 7th and there are 8 available slots that meet his needs, the driver is assigned a space 114 in which to park. If the driver is instead ranked 9th, parking space 114 assignment is declined, and the driver must find alternate parking arrangements such as parking somewhere other than in parking lot 108. In addition, if the driver is highly-ranked but has a vehicle that needs special parking space accommodations (e.g., large vehicle, electricity access, etc.) and no such accommodating parking spaces 114 are available, the driver may be refused a parking space assignment notwithstanding his high rank.

Once a parking space 114 is assigned, the system 100 may re-visit the employee's calendar to update any changes. For example, if the assigned parking space 114 is reserved for a time that the calendar now indicates will not be needed, the assigned space may be unreserved for the employee, and the employee may be notified. The unreserved space may then be assigned to another driver by repeating method 400.

The system 100 avoids granting alternating access/permission to parking spaces when the length of stay is for multiple time periods for one driver but for fewer time periods for a second driver. For example, an employee who would park an entire eight-hour shift in a 15-minute block time period should not be granted access for the first two hours and for the last two hours because a higher-reputation visitor is expected during the middle four hours. In this case, the high-reputation visitor may have priority over the employee such that the employee is not assigned a parking space for that day, even if the respective parking space is vacant for the hours outside the visitor's parking time.

At block 416, the driver is notified whether a parking space 114 is assigned to his vehicle or not. The driver may be notified upon arrival at the parking lot 108 in one embodiment, but in a preferred embodiment, the driver is notified prior to arriving at the parking lot 108 (e.g., en route or while still at home) so that time is not spent driving to the parking lot 108 only to find out that parking is not available. The driver may be notified by mobile communication device 122 and may receive the notice on a visual display of mobile communication device 122 or by a telephone call of mobile communication device 122. In some embodiments, the driver may be alternatively notified by a system of the vehicle 106 to which the parking assignment is transmitted or by issuing a ticket or displaying a quick response (QR) or other machine-readable code at entry gate 124 of parking lot 108.

In certain implementations, a warning notification may be sent to employees via mobile communication device 122 to indicate they are about to be bumped. Such a warning notification may be generated as server 102 refreshes the parking assignments by re-processing method 400 periodically. This notification may let the employee explicitly confirm whether or not he will actually be arriving, which in turn modifies his reputation score in reputation database 130.

At block 418, method 400 records the driver's use of the assigned parking space 116. Both the actual allocation database 132 and the reputation database 130 may be modified. The actual allocation database 132 can record the date and times of the use of the assigned space 116 when the driver arrives and parks in the assigned space 116, The reputation database 130 may be modified to update the driver's reputation score, which may be positively affected if the space 116 is assigned and used and which may be negatively affected if the space 116 is assigned and not used. As described above, drivers who are assigned unoccupied parking spaces 116 and fail to use them are likely to be denied future parking assignments. Furthermore, should the driver be detected (e.g., by devices or humans) to have parked in a different space than the one that was assigned, the reputation database 130 may also be updated to reflect the driver's behavior and have his reputation score reduced as a penalty.

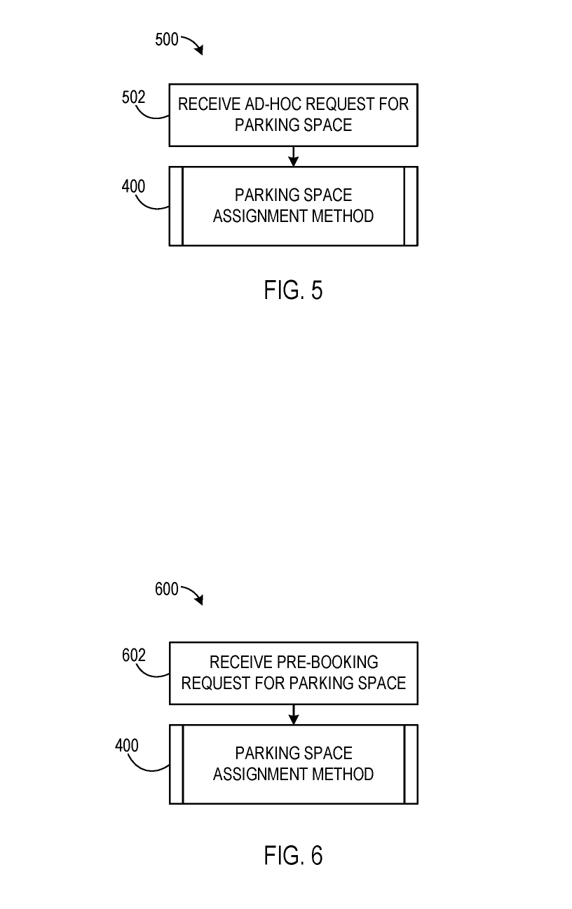

FIG. 5 is a flow diagram illustrating an ad-hoc automatic parking space assignment method 500 performed by the server 102 according to one embodiment. Method 500 includes automatically determining parking space availability in the parking lot 108 for the vehicle 106 of a visitor or employee who is not entered into the people database 126 and who arrives at the parking lot 108 seeking a parking space assignment. At block 502, an ad-hoc request for a parking space is received. The request may be received when a car arrives at the parking lot 108. The system 100 may determine who the driver is, for example, by an identity badge, by reading a license place, or by letting the driver verbally converse with a receptionist.

Based on receiving the request, the system 100 can then perform method 400 as described herein to look up the particular driver, understand their particular vehicle needs, and look at their rank, etc. in order to determine whether or not a parking space 114 should be assigned. The rank of the driver may be influenced depending on the role of the driver seeking ad-hoc assignment. If an ad-hoc driver arrives, he may be given a stack rank dynamically. For example, an employee may get a relatively low score (e.g., 0.3 or 30%), which might indicate that since he has already arrived, he may get a slot. A visitor may be granted a relatively higher score if the business chooses to avoid turning away visitors who are not aware of the pre-booking preference. Generally, however, the business may instead prefer to allocate their spaces to reliable employees who are likely to arrive and pre-booked visitors than to ad-hoc employees or visitors.

FIG. 6 is a flow diagram illustrating a pre-booking automatic parking space assignment method 600 performed by the server 102 according to one embodiment. Method 600 includes receiving, at block 602, a request for an assigned parking space 114 for a future date or time period and for a specific driver (e.g., employee, visitor, contractor, etc.). Execution of method 400 by server 102 may automatically occur for time periods up to a certain point in the future. For example, method 400 may be executed to assign parking spaces 114 for one month into the future. However, other periods of future assignments (e.g., one week, two weeks, the remaining workdays in the current work week, etc.) may alternatively be determined. An employee or administrator may know that a parking space 116 will be required for the employee or for a visitor for a time period beyond that automatically determined by the server 102. A request for a pre-booked parking space 116 may thus be initiated to pre-book or to pre-assign a parking space 116.

After the request for a pre-booked parking space 116 is received (block 602), the system 100 can then perform method 400 as described herein to calculate the pre-booked parking space assignment for the future time period. The system 100 may determine whether or not to assign a parking space 114 based on what it can analyze for the future time period such as, for example, by reviewing accessible calendars to predict usage requirements. A parking space 114 may be assigned if the allocation score of the pre-booking driver and other factors warrant a parking space assignment. However, while a pre-booked parking space 114 may be assigned ahead of time, the server 102 may retract the pre-booked assignment as the future time period nears if higher-scored drivers require the pre-booked space 114 or for other reasons. It may be possible to request a pre-booked space 114 that is guaranteed not to be bumped in favor of another driver if the business reasons allow for such options when requesting pre-booked parking spaces 114.

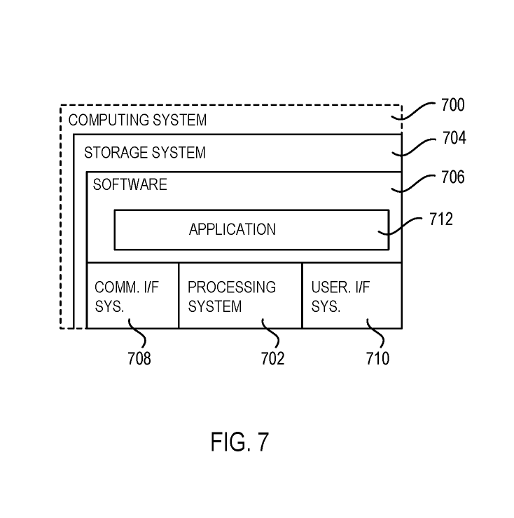

FIG. 7 illustrates a computing system 700, which is representative of any system or collection of systems in which the various applications, services, scenarios, and processes disclosed herein may be implemented. Examples of computing system 700 include, but are not limited to, desktop computers, laptop computers, tablet computers, computers having hybrid form-factors, mobile phones, smart televisions, wearable devices, server computers, blade servers, rack servers, and any other type of computing system (or collection thereof) suitable for carrying out the application launching operations described herein. Such systems may employ one or more virtual machines, containers, or any other type of virtual computing resource in the context of supporting enhanced group collaboration.

Computing system 700 may be implemented as a single apparatus, system, or device or may be implemented in a distributed manner as multiple apparatuses, systems, or devices. Computing system 700 includes, but is not limited to, processing system 702, storage system 704, software 706, communication interface system 708, and user interface system 710. Processing system 702 is operatively coupled with storage system 704, communication interface system 708, and user interface system 710.

Processing system 702 loads and executes software 706 from storage system 704. Processing system 702 may be or reside on, for example, server 102. Software 706 includes application 712, which is representative of a software application executed by a processor and programmed to execute the methods described herein. When executed by processing system 702 to assign parking spaces, application 712 directs processing system 702 to operate as described herein for at least the various processes, operational scenarios, and sequences discussed in the foregoing implementations. Computing system 700 may optionally include additional devices, features, or functionality not discussed for purposes of brevity.

Referring still to FIG. 7, processing system 702 may comprise a micro-processor and other circuitry that retrieves and executes software 706 from storage system 704. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 704 may comprise any computer readable storage media readable by processing system 702 and capable of storing software 706. Storage system 704 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 704 may also include computer readable communication media over which at least some of software 706 may be communicated internally or externally. Storage system 704 may be implemented as a single storage device, but may also be implemented across multiple storage devices or sub-systems co-located or distributed relative to each other. Storage system 704 may comprise additional elements, such as a controller, capable of communicating with processing system 702 or possibly other systems.

Software 706 in general, and application 712 in particular, may be implemented in program instructions and among other functions may, when executed by processing system 702, direct processing system 702 to operate as described with respect to the various operational scenarios, sequences, and processes illustrated herein. For example, application 712 may include program instructions for implementing parking space assignment procedures such at that described in methods 300, 400, 500, and 600.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 706 may include additional processes, programs, or components, such as operating system software, virtual machine software, or other application software, in addition to or that include application 712. Software 706 may also comprise firmware or some other form of machine-readable processing instructions executable by processing system 702.

In general, application 712 may, when loaded into processing system 702 and executed, transform a suitable apparatus, system, or device (of which computing system 700 is representative) overall from a general-purpose computing system into a special-purpose computing system customized to enhance entity classification operations. Indeed, encoding application 712 on storage system 704 may transform the physical structure of storage system 704. The specific transformation of the physical structure may depend on various factors in different implementations of this description. Examples of such factors may include, but are not limited to, the technology used to implement the storage media of storage system 704 and whether the computer-storage media are characterized as primary or secondary storage, as well as other factors.

For example, if the computer readable storage media are implemented as semiconductor-based memory, application 712 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 708 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 710 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 710. In some cases, the input and output devices may be combined in a single device, such as a display capable of displaying images and receiving touch gestures. The aforementioned user input and output devices are well known in the art and need not be discussed at length here.

User interface system 710 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface, in which a user interface to an application may be presented.

Communication between computing system 700 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well-known and need not be discussed at length here. In any of the aforementioned examples in which data, content, or any other type of information is exchanged, the exchange of information may occur in accordance with any of a variety of well-known data transfer protocols.

Certain inventive aspects may be appreciated from the foregoing disclosure, of which the following are various examples.

### Example 1

A computing apparatus comprising: one or more computer readable storage media; a processing system operatively coupled with the one or more computer readable storage media; and program instructions stored on the one or more computer readable storage media for allocating a plurality of parking spaces in a parking lot that, when executed by the processing system, direct the processing system to at least: enumerate a set of vehicles likely to park in the parking lot during a given time period, each vehicle associated with a respective driver; determine an availability of each parking space of the plurality of parking spaces during the given time period; identify at least one decision factor corresponding with each respective driver, wherein the at least one decision factor comprises a priority of a respective driver to be assigned a parking space; assign a parking space (“assigned parking space”) of the plurality of parking spaces for a vehicle (“authorized vehicle”) of the set of vehicles for the given time period based on the availability of the assigned parking space and based on at least one decision factor; and notify, via a user interface, the respective driver of the authorized vehicle of the assigned parking space.

### Example 2

The computing apparatus of Example 1 wherein the at least one decision factor further comprises a likelihood that the respective driver will need the assigned parking space during the given time period based on historical information data indicating one or more times the respective driver of the authorized vehicle previously used a parking space of the parking lot during similar time periods.

### Example 3

The computing apparatus of Examples 1-2 wherein the at least one decision factor further comprises at least one of a job position and a job seniority of the respective driver.

### Example 4

The computing apparatus of Examples 1-3 wherein the at least one decision factor further comprises a reputation of the respective driver calculated based on a comparison of a number of parking space assignments to the respective driver with a number of actual uses of the number of the number of parking space assignments by the respective driver.

### Example 5

The computing apparatus of Examples 1-4 wherein the at least one decision factor further comprises historical data indicating: a number of times the respective driver was historically assigned a parking space; and a number of times the respective driver was historically denied a parking space.

### Example 6

The computing apparatus of Examples 1-5 wherein the at least one decision factor further comprises travel information indicating that the respective driver is en-route to the parking lot.

### Example 7

The computing apparatus of Examples 1-6 wherein, to notify the respective driver, the program instructions direct the processing system to notify the respective driver via a user interface of a mobile communication device.

### Example 8

A method for allocating parking spaces in a parking lot comprising: (A) enumerating a set of vehicles likely to park in the parking lot during a given time period, each vehicle associated with a respective driver; (B) determining an availability of each parking space of the plurality of parking spaces during the given time period; (C) identifying at least one decision factor corresponding with each respective driver, wherein the at least one decision factor comprises a priority of a respective driver to be assigned a parking space; (D) assigning an assigned parking space of the plurality of parking spaces for an authorized vehicle of the set of vehicles for the given time period based on the availability of the assigned parking space and based on at least one decision factor; and (E) notifying the respective driver of the authorized vehicle of the assigned parking space via a user interface.

### Example 9

The method of Example 8 wherein enumerating a set of vehicles comprises accessing an electronic calendar of each the drivers to determine which drivers are available for the given time period.

### Example 10

The method of Examples 8-9 wherein enumerating a set of vehicles comprises accessing an electronic calendar of each the drivers to determine which drivers that were previously available for the given time period have become unavailable for the given time period.

### Example 11

The method of Examples 8-10 further comprising: determining that the driver of the authorized vehicle is no longer available for the given time period; revoking the assigned parking space; and notifying the driver of the revoked parking space via the user interface.

### Example 12

The method of Examples 8-11 wherein accessing the electronic calendar comprises accessing one or more calendar items in the electronic calendar, the one or more calendar items comprising an identifier indicating a parking need of the driver of the authorized vehicle during the given time period; and wherein the identifier indicates that a parking space will be needed during the given time period.

### Example 13

The method of Examples 8-12 wherein the identifier indicates that a parking space will not be needed during the given time period.

### Example 14

The method of Examples 8-13 wherein enumerating a set of vehicles comprises receiving an ad-hoc request for immediate parking for a vehicle that has arrived at the parking lot without a prior assigned parking space.

### Example 15

The method of Examples 8-14 further comprising performing steps (A)-(E) for each given time period of a block of time periods.

### Example 16

The method of Examples 8-15 wherein enumerating a set of vehicles comprises receiving a pre-booking request to assign the parking space for a future period of time, wherein the future period of time is beyond a time of the block of time periods.

### Example 17

One or more computer readable storage media having program instructions stored thereon for allocating parking spaces in a parking lot, wherein the program instructions, when executed by a processing system, direct the processing system to at least: enumerate a set of vehicles likely to park in the parking lot during a given time period, each vehicle associated with a respective driver; determine an availability of each parking space of the plurality of parking spaces during the given time period; identify at least one decision factor corresponding with each respective driver, wherein the at least one decision factor comprises a priority of a respective driver to be assigned a parking space; assign a reserved parking space of the plurality of parking spaces for an authorized vehicle of the set of vehicles for the given time period based on the availability of the assigned parking space and based on at least one decision factor; and notify the respective driver of the authorized vehicle of the assigned parking space via a user interface.

### Example 18

The one or more computer readable storage media of Example 17 wherein the program instructions further direct the processing system to receive a user input defining parking space characteristics for each parking space in the parking lot.

### Example 19

The one or more computer readable storage media of Examples 17-18 wherein the parking space characteristics define, for each parking space, at least one of a location of the parking space within the parking lot, an ownership status of the parking space, a shared status indicating that the parking space is shared by multiple businesses, size and weight characteristics of vehicles capable of parking in the parking space, and a location of the parking space related to a target destination.

### Example 20

The one or more computer readable storage media of Examples 17-19 wherein the program instructions further direct the processing system to receive the user input via an administrative portal; and wherein the program instructions further direct the processing system to receive, via the administrative portal, at least one of: a user input requesting a display of one or more authorized vehicles assigned a respective reserved parking space; a user input adding an ad-hoc vehicle to the enumerated set of vehicles likely to park in the parking lot during the given time period; and a user input manually adjusting respective driver data correlating with the at least one decision factor.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A computing apparatus comprising:
one or more computer readable storage media;
a processing system operatively coupled with the one or more computer readable storage media; and
program instructions stored on the one or more computer readable storage media for allocating a plurality of parking spaces in a parking lot that, when executed by the processing system, direct the processing system to at least:
enumerate a set of vehicles likely to park in the parking lot during a given time period, each vehicle associated with a respective driver;
determine an availability of each parking space of the plurality of parking spaces during the given time period;
identify at least one decision factor corresponding with each respective driver, wherein the at least one decision factor comprises a priority of a respective driver to be assigned a parking space;
assign a parking space (“assigned parking space”) of the plurality of parking spaces for a vehicle (“authorized vehicle”) of the set of vehicles for the given time period based on the availability of the assigned parking space and based on at least one decision factor; and
notify, via a user interface, the respective driver of the authorized vehicle of the assigned parking space.

2. The computing apparatus of claim 1, wherein the at least one decision factor further comprises a likelihood that the respective driver will need the assigned parking space during the given time period based on historical information data indicating one or more times the respective driver of the authorized vehicle previously used a parking space of the parking lot during similar time periods.

3. The computing apparatus of claim 1, wherein the at least one decision factor further comprises at least one of a job position and a job seniority of the respective driver.

4. The computing apparatus of claim 1, wherein the at least one decision factor further comprises a reputation of the respective driver calculated based on a comparison of a number of parking space assignments to the respective driver with a number of actual uses of the number of the number of parking space assignments by the respective driver.

5. The computing apparatus of claim 1, wherein the at least one decision factor further comprises historical data indicating:
a number of times the respective driver was historically assigned a parking space; and
a number of times the respective driver was historically denied a parking space.

6. The computing apparatus of claim 1, wherein the at least one decision factor further comprises travel information indicating that the respective driver is en-route to the parking lot.

7. The computing apparatus of claim 1, wherein, to notify the respective driver, the program instructions direct the processing system to notify the respective driver via a user interface of a mobile communication device.

8. A method for allocating parking spaces in a parking lot comprising:
(A) enumerating a set of vehicles likely to park in the parking lot during a given time period, each vehicle associated with a respective driver;
(B) determining an availability of each parking space of the plurality of parking spaces during the given time period;
(C) identifying at least one decision factor corresponding with each respective driver, wherein the at least one decision factor comprises a priority of a respective driver to be assigned a parking space;
(D) assigning an assigned parking space of the plurality of parking spaces for an authorized vehicle of the set of vehicles for the given time period based on the availability of the assigned parking space and based on at least one decision factor; and
(E) notifying the respective driver of the authorized vehicle of the assigned parking space via a user interface.

9. The method of claim 8, wherein enumerating a set of vehicles comprises accessing an electronic calendar of each the drivers to determine which drivers are available for the given time period.

10. The method of claim 9, wherein enumerating a set of vehicles comprises accessing an electronic calendar of each the drivers to determine which drivers that were previously available for the given time period have become unavailable for the given time period.

11. The method of claim 10 further comprising:
determining that the driver of the authorized vehicle is no longer available for the given time period;
revoking the assigned parking space; and
notifying the driver of the revoked parking space via the user interface.

12. The method of claim 9, wherein accessing the electronic calendar comprises accessing one or more calendar items in the electronic calendar, the one or more calendar items comprising an identifier indicating a parking need of the driver of the authorized vehicle during the given time period; and
wherein the identifier indicates that a parking space will be needed during the given time period.

13. The method of claim 12, wherein the identifier indicates that a parking space will not be needed during the given time period.

14. The method of claim 8, wherein enumerating a set of vehicles comprises receiving an ad-hoc request for immediate parking for a vehicle that has arrived at the parking lot without a prior assigned parking space.

15. The method of claim 8 further comprising performing steps (A)-(E) for each given time period of a block of time periods.

16. The method of claim 15 wherein enumerating a set of vehicles comprises receiving a pre-booking request to assign the parking space for a future period of time, wherein the future period of time is beyond a time of the block of time periods.

17. One or more computer readable storage media having program instructions stored thereon for allocating parking spaces in a parking lot, wherein the program instructions, when executed by a processing system, direct the processing system to at least:
enumerate a set of vehicles likely to park in the parking lot during a given time period, each vehicle associated with a respective driver;
determine an availability of each parking space of the plurality of parking spaces during the given time period;
identify at least one decision factor corresponding with each respective driver, wherein the at least one decision factor comprises a priority of a respective driver to be assigned a parking space;
assign a reserved parking space of the plurality of parking spaces for an authorized vehicle of the set of vehicles for the given time period based on the availability of the assigned parking space and based on at least one decision factor; and
notify the respective driver of the authorized vehicle of the assigned parking space via a user interface.

18. The one or more computer readable storage media of claim 17, wherein the program instructions further direct the processing system to receive a user input defining parking space characteristics for each parking space in the parking lot.

19. The one or more computer readable storage media of claim 18, wherein the parking space characteristics define, for each parking space, at least one of a location of the parking space within the parking lot, an ownership status of the parking space, a shared status indicating that the parking space is shared by multiple businesses, size and weight characteristics of vehicles capable of parking in the parking space, and a location of the parking space related to a target destination.

20. The one or more computer readable storage media of claim 18, wherein the program instructions further direct the processing system to receive the user input via an administrative portal; and
wherein the program instructions further direct the processing system to receive, via the administrative portal, at least one of:
a user input requesting a display of one or more authorized vehicles assigned a respective reserved parking space;
a user input adding an ad-hoc vehicle to the enumerated set of vehicles likely to park in the parking lot during the given time period; and
a user input manually adjusting respective driver data correlating with the at least one decision factor.
